(19) United States
(12) Patent Application Publication
(10) Pub. No.: US 2003/0021642 A1
(43) Pub. Date: Jan. 30, 2003

(54) Multi-component bit

(76) Inventor: Mark E. Bankston, Acworth, GA (US)

Correspondence Address: Myers & Associates, Intellectual Property Law, P.C., Building 3, Suite 200, 1827 Powers Ferry Road, Atlanta, GA, 30339, US

(21) Appl. No.: 09/918,417

(22) Filed: Jul. 30, 2001

(51) Int. Cl. B23B 27/14; B26D 1/12

(52) U.S. Cl. 407/35; 407/42

(57) ABSTRACT

A multi-component bit for a rotational cutting tool such as a router or shaper; the bit having adjustable blades, thereby enabling repositioning of worn cutting blades, thus compensating for cutting edge wear to maintain a reproducible depth of cut, and having replaceable blades, thereby enabling removal of damaged or chipped blades and substitution with a clean, sharp edge, thereby preventing the total loss of a bit and extending the life thereof.

### TECHNICAL FIELD

The present invention relates generally to power tools and, more specifically, to a multi-component bit having adjustable blades enabling compensation for cutting edge wear, thus maintaining a reproducible depth of cut, and replaceable blades enabling removal of a damaged or chipped cutting edge and substitution with a clean, sharp edge, thereby preventing the total loss of a bit and extending the life thereof. The present invention is particularly useful in, although not strictly limited to, router applications wherein an individual desires to extend the useful life of an expensive bit by enabling relatively simple and inexpensive replacement of damaged parts, thus avoiding full bit replacement.

### BACKGROUND OF THE INVENTION

Routers are useful, versatile and highly accurate tools. A skilled woodworker can quickly rout grooves with precision and create shaped edge patterns and profiles. Most woodworkers agree, however, that quality results are dependent upon quality equipment, and that utilization of the proper router and bit is critical.

Routers are available with a variety of features. For instance, a fixed base router has a preset depth of cut, wherein a plunge router is depth adjustable to enable an increased variety of cuts. A woodworker's router selection can also be influenced by horsepower or options, such as electronic variable speed. Each accessory feature, however, typically adds not only to the weight of the router thereby limiting portability, but also adds to the cost of the router thereby limiting affordability.

After a woodworker makes the investment necessary to obtain a router, the endless creative possibilities are limited only by the availability of an appropriate bit. Bits are manufactured with a wide variety of characteristics, such as whether or not they are pilot bits and whether they are solid carbide, carbide tipped or high speed steel (HSS) bits. The selection between a pilot and non-pilot bit depends upon the type of work to be done, wherein edge woodwork often necessitates a pilot bit. The selection between a solid carbide, carbide tipped and HSS bit, however, is based on other factors.

Carbide is very dense and hard and more resistant to heat than steel. In addition, a sharpened carbide edge lasts longer than a steel edge. However, carbide is very expensive and, even though most bits are only carbide tipped (not solid carbide), carbide tipped bits are disadvantageously costly for the average woodworker. Even so, and despite the brittle nature and potential chipping of carbide, carbide tipped bits are presently the most popular bits. HSS tips are much less expensive, however, they disadvantageously dull quickly and require frequent sharpening. An HSS tip with a titanium nitride coating can decrease the frequency of sharpening, however, only temporarily.

Another bit feature is size, or shank diameter, with the most common being ¾, ½ and ¼-inch. The larger the shank, or arbor, the less likely the bit is to bend or break and the less vibration that is generated. Unlike tip material, shank or arbor size typically doesn't influence the cost of a bit. However, to be able to utilize the larger shank bits, a more expensive router is required.

Another variable feature amongst bits is the design of the cutter. The cutter, or the blade tip, of the bit is responsible for the resulting shape that is cut into the wood. Many types of bits exist to enable many specialty cuts, such as, for exemplary purposes only, cabinet-making bits, glue joint bits, profile bits and various types of trim bits. Thus, it is necessary for a woodworker to purchase a specially selected bit for each type of specialty routing work.

Wherein carbide is the preferred tip material, the purchase of multiple bits can be expensive. Repeated usage causes wear on the tips and in order to obtain reproducible cutting depths, results in the need for replacement. In addition, since carbide is prone to chipping, damage can occur to render the tip unusable, also necessitating replacement.

Since a substantial investment can be necessary in order to obtain the router and bits to enable complex woodcutting, woodworkers typically count on ongoing and reproducible performance therefrom. However, wherein a quality result is desired, router bits must be completely replaced when they become damaged or worn. For many, the expense associated with full replacement is prohibitive.

Therefore, it is readily apparent that there is a need for a multi-component bit apparatus having adjustable blades enabling compensation for cutting edge wear, thus maintaining a reproducible depth of cut, and replaceable blades enabling removal of a damaged or chipped cutting edge and substitution with a clean, sharp edge, thereby preventing the total loss of the bit and extending the life thereof, thus preventing the above-discussed disadvantages.

### BRIEF SUMMARY OF THE INVENTION

Briefly described, in a preferred embodiment, the present invention overcomes the above-mentioned disadvantages, and meets the recognized need for such a device, by providing a multi-component bit device enabling repositioning of worn cutting blades and removal of damaged or chipped blades, thereby avoiding the expense of bit replacement.

According to its major aspects and broadly stated, the present invention is a multi-component bit wherein the useful life is extended through relatively simple and inexpensive replacement of damaged or worn parts, wherein blades are adjustable to enable compensation for cutting edge wear and blades are replaceable to enable removal and replacement of a damaged or chipped cutting edge.

More specifically, the preferred embodiment of the present invention is an elongated shank or arbor with two shaped blades removably positioned proximate to the distal end thereof, wherein the proximal end of the arbor is dimensioned to be removably secured by a collet of a power woodworking tool, such as, for exemplary purposes only, a router or a shaper. In the preferred embodiment, each shaped blade has a cutting end and a mounting end, wherein the cutting end is carbide tipped and shaped to impart a correspondingly desired shape or cut into a workpiece. The mounting end has splines defined therein, whereby each shaped blade is adjustably, independently and reproducibly positioned proximate to the distal end of the arbor. The arbor has two mounting ports defined proximate to the distal end thereof, wherein at least one inner surface of each mounting port carries splines that correspond to the splines provided on the mounting end of each shaped blade, thereby enabling a user to fix each shaped blade into a selected position within each mounting port, thereby limiting the extended length of each shaped blade relative to the arbor. Setscrews are provided on the distal end of the arbor, whereby each shaped blade is locked within a mounting port during use of the multi-component bit.

Whereby the cutting edge becomes worn, each shaped blade can be easily repositioned relative to the splines, thereby allowing a user to compensate for the wear thereof. Whereby the cutting edge becomes damaged, each shaped blade can be easily replaced, thereby allowing a user to avoid full replacement of the bit. Wherein a pilot bit may be desired, the multi-component bit may also have a bearing positioned on the distal end of the arbor.

A feature and advantage of the present invention is the ability of such a device to provide a multi-component bit that is long lasting, economical and easy to use.

Another feature and advantage of the present invention is the ability of such a device to provide a multi-component bit that enables quality woodworking results.

Another feature and advantage of the present invention is the ability of such a device to provide a multi-component bit that can be utilized in a router, shaper or other appropriate rotational cutting apparatus.

Another feature and advantage of the present invention is the ability of such a device to provide a multi-component bit enabling an individual to avoid the expense of full bit replacement by enabling adjustable positioning of a shaped blade to compensate for wear thereof.

Another feature and advantage of the present invention is the ability of such a device to provide a multi-component bit enabling an individual to avoid the expense of full bit replacement by enabling replacement of a damaged shaped blade.

Another feature and advantage of the present invention is the ability of such a device to provide a multi-component bit enabling long-term utilization without full replacement thereof.

Another feature and advantage of the present invention is the ability of such a device to provide a multi-component bit that enables a user to possess and utilize a varied selection of shaped cutting edges without the expense of purchasing a full bit for each desired shape.

Another feature and advantage of the present invention is the ability of such a device to provide a multi-component bit that enables a user to possess and utilize one arbor that can receive a variety of shaped blades, thereby enabling the completion of any desired woodworking cut with minimal bit purchase expense.

Another feature and advantage of the present invention is the ability of such a device to provide a multi-component bit that enables quick and easy removal of shaped blades to enable sharpening thereof.

Another feature and advantage of the present invention is the ability of such a device to provide a multi-component bit that has easily interchangeable shaped blades, thereby eliminating the financial constraints of purchasing a full bit selection.

These and other objects, features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a perspective side view of a multi-component bit apparatus according to a preferred embodiment of the present invention, showing two ¼ round shaped blades mounted therein and an attachable bearing removed therefrom.

FIG. 2 is a perspective side view of the multi-component bit apparatus of FIG. 1, showing the arbor, mounting head, one mounting port with no shaped blade positioned therein and a set screw and washer removed therefrom.

FIG. 3a is a front surface of a ¼ round shaped blade for the multi-component bit apparatus of FIG. 1.

FIG. 3b is a front surface of a patterned profile shaped blade for the alternate embodiment multi-component bit apparatus of FIG. 6.

FIG. 3c is a rear surface of a cove molding shaped blade for the multi-component bit apparatus of FIG. 1.

FIG. 3d is a cross-sectional view of a wood workpiece following a cut with a cove molding shaped pilot bit.

FIG. 4 is a bottom view of a first unused shaped blade and a second partially worn shaped blade for the multi-component bit apparatus of FIG. 1, showing the relationship of the adjustment splines and the cutting edge as wear progresses.

FIG. 5 is a bottom view of the multi-component bit apparatus of FIG. 1, showing the base of the mounting head with a pilot bearing and two mounting ports with no shaped blades positioned therein.

FIG. 6 is a bottom view of a multi-component bit apparatus according to an alternate embodiment of the present invention, showing the base of the mounting head with a pilot bearing and two mounting ports with shaped blades positioned therein.

FIG. 7 is a perspective side view of the multi-component bit apparatus of FIG. 6, showing two ¼ round shaped blades mounted thereto and a pilot bearing attached thereto.

### DETAILED DESCRIPTION OF THE PREFERRED AND ALTERNATE EMBODIMENTS

In describing the preferred and alternate embodiments of the present invention, as illustrated in the figures, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIG. 1, the present invention is a multi-component bit device 10 comprising elongated shank 20 and at least one removable blade 60. Preferably, shank 20 of multi-component bit device 10 is steel, however, other suitably strong materials could be utilized, such as, for exemplary purposes only, carbide, iron, high speed steel (HSS), HSS with titanium nitride coating, other metals, alloys or synthetic materials or combinations thereof.

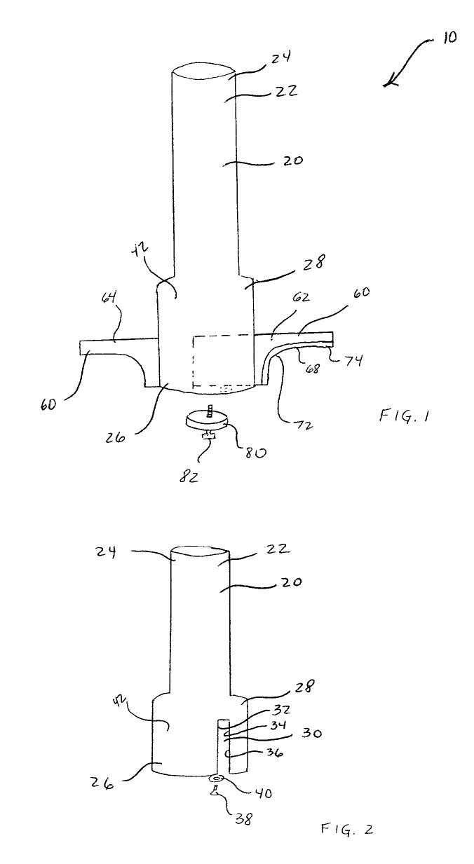

Referring now to FIG. 1 and FIG. 2, elongated shank 20 defines arbor 22, wherein arbor 22 has proximate end 24 and distal end 26. Preferably, proximate end 24 is dimensioned to be received and gripped by a router or shaper sleeve or collet, wherein arbor 22 functions as a rotating shaft driven by the router or shaper motor to turn cutting blade 60. Preferably, proximate end 24 of arbor 22 has a ¾-inch diameter to correspond with known routers and shapers. While a ¾-inch diameter is preferred, one skilled in the art would readily recognize that a variety of shank diameters are anticipated within the scope of the present invention, such as, for exemplary purposes only, ¼, ½ or ⅜ inch, to enable utilization with any available router, shaper or other rotational cutting tool. Preferably, distal end 26 of arbor 22 has a larger circumference than proximate end 24 thereof. However, one skilled in the art would readily recognize that the relative difference in circumference between distal end 26 and proximate end 24 of arbor 22 could vary, wherein the circumference of arbor 22 could be substantially consistent throughout the length thereof without departing from the scope of the present invention.

Preferably, distal end 26 of arbor 22 defines mounting head 28, wherein at least one removable blade 60 is removably positioned therein. Mounting head 28 preferably has at least one mounting aperture 30 defined therein. Mounting aperture 30 preferably defines a substantially rectangular shaped recess having first inner wall 32 and second inner wall 34. Preferably, second inner wall 34 has a set of splines 36 defined thereon, whereby movement of blade 60 may be limited thereby. Preferably, the set of splines 36 of second inner wall 34 extends substantially perpendicular from distal end 26 of mounting head 28, substantially parallel with each other, defining a series of ridges 36a and troughs 36b.

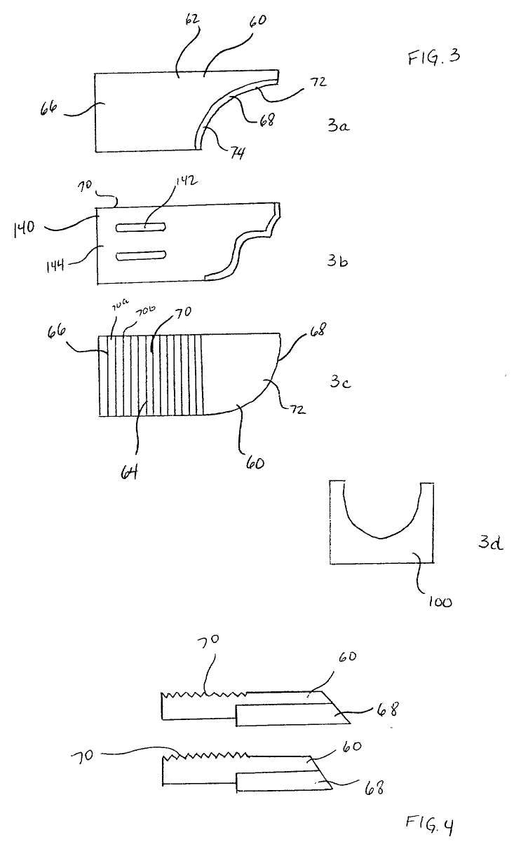

Referring now to FIG. 1 and FIG. 3, each removable blade 60 has front surface 62, rear surface 64, mounting end 66 and cutting end 68. Preferably, rear surface 64 of blade 60 has at least two splines 70 defined therein, proximate to mounting end 66. Splines 70 define ridges 70a and troughs 70b on rear surface 64 of blade 60 and preferably extend substantially across rear surface 64 of blade 60, substantially parallel with mounting end 66 and substantially parallel with each other, wherein splines 70 of blade 60 ensure reproducible and secure positioning of mounting end 66 of blade 60 by mating with the set of splines 36 of second inner wall 34 of mounting aperture 30, thereby ensuring alignment of cutting end 68. Wherein a plurality of splines 38 may be defined on second inner wall 34 of mounting aperture 30 and a plurality of splines 70 may be defined on rear surface 64 of blade 60, blade 60 may be fixed in a plurality of reproducible positions within mounting aperture 30, thereby enabling adjustment and repositioning to compensate for wear realized on cutting end 68. FIG. 4 demonstrates the progression of wear on cutting end 68 of blade 60 and the relationship of splines 70 thereto, wherein the overall length of blade 60 is decreased as wear progresses. Preferably, each movement of blade 60 within splines 70 and 36 corresponds to an incrementally precise positional change, such as, for exemplary purposes only, 1/64^{th} or 1/132^{nd} of an inch.

Preferably, cutting end 68 defines shape 72, wherein shape 72 has cutting edge 74, and wherein cutting edge 74 imparts a correspondingly shaped cut, groove or profile in a workpiece 100. One skilled in the art would readily recognize that an infinite variety of shapes may be utilized for cutting edge 74, such as, for exemplary purposes only, a ¼ round shaped blade as best seen in FIG. 3a, a patterned profile shaped blade as best seen in FIG. 3b and a cove molding shaped blade as best seen in FIG. 3c, wherein each shape 72 imparts a different cut, groove or profile in a workpiece such as shown in FIG. 3d.

Preferably, blade 60 is steel, however, other suitably strong materials could be utilized, such as, for exemplary purposes only, carbide, iron, high speed steel (HSS), HSS with titanium nitride coating, other strong metals, alloys or synthetic materials or combinations thereof. Preferably, blade 60 is carbide tipped, wherein cutting edge 74 of blade 60 is carbide.

As best seen in FIG. 5, a set screw 38 and washer 40 are preferably provided on distal end 26 of arbor 22 for each blade 60, whereby each blade 60 is locked within mounting aperture 30 of mounting head 28 during use of multi-component bit 10. However, although washer 40 is preferred, one skilled in the art would readily recognize that alternative components, such as, for exemplary purposes only, a substantially square or rectangular plate having at least one aperture therethrough to enable insertion of at least one set screw 38 therethrough. Preferably, set screw 38 is positioned adjacent to mounting aperture 30, wherein placement of washer 40 between set screw 38 and mounting head 28 positions a portion of washer 40 to block mounting aperture 30, thereby preventing exit of blade 60 therefrom. One skilled in the art would readily recognize that alternative means for securing blade 60 within mounting aperture 30 could be utilized without departing from the scope of the present invention, such as, for exemplary purposes only, set screw 38 could be utilized independently without washer 40 or a securing means could be positioned, accessed and secured through arbor wall 42.

Preferably, multi-component bit 10 has removable bearing 80 centrally positioned on distal end 26 of arbor 22, thereby enabling a user to utilize multi-component bit 10 as a pilot bit or a non-pilot bit. Preferably, bearing 80 is securely and removably held into place with screw 82.

In one alternate embodiment, multi-component bit 10 could have a permanently mounted bearing centrally positioned on distal end 26 of arbor 22, wherein multi-component bit 10 would be a pilot bit.

In one alternate embodiment, distal end 26 of multi-component bit 10 could be formed wherein a bearing could not be positioned or secured thereon, wherein multi-component bit 10 would be a non-pilot bit.

In one alternate embodiment, set screw 38 of mounting head 26 could enter mounting aperture 30 through either side wall 32 or side wall 34, wherein an access bore could be provided through arbor wall 42 whereby a screwdriver, allen wrench or hex key could be utilized for removably securing set screw 38.

In one alternate embodiment, mounting head 26 of multi-component bit 10 could have one mounting aperture defined therein, wherein the mounting aperture could be dimensioned to receive an elongated blade having a first end with a first cutting edge surface and a second end with a second opposing cutting edge surface, wherein the elongated dual-edge blade could be removably secured within mounting head 26.

In one alternate embodiment, mounting head 26 of multi-component bit 10 could have a plurality of mounting apertures defined therein, wherein a plurality of blades could be removably positioned therein.

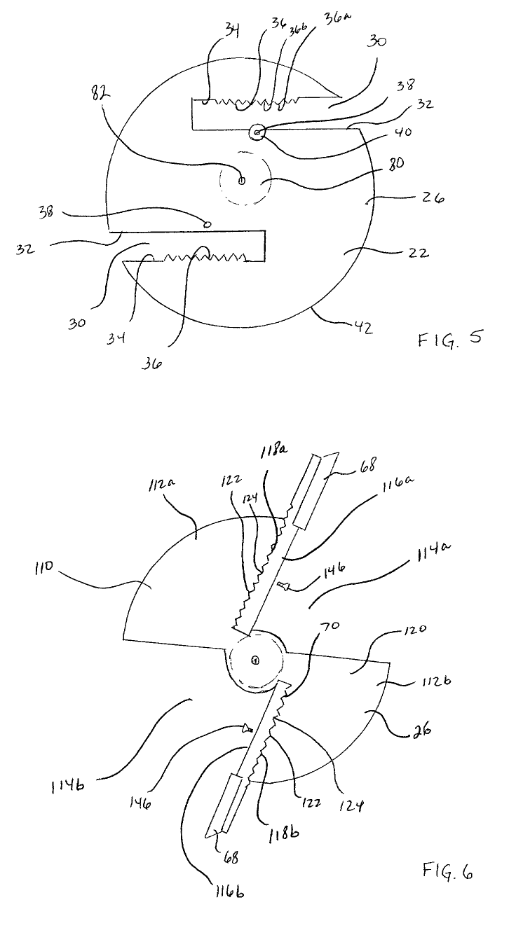

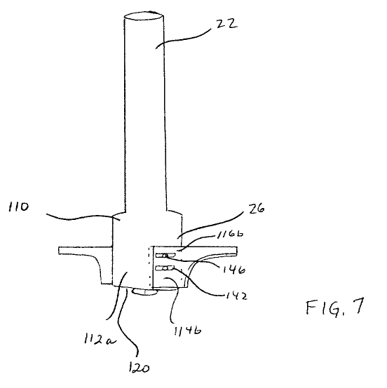

In one alternate embodiment, as best seen in FIG. 3b, FIG. 6 and FIG. 7, distal end 24 of arbor 22 could define mounting head 110, wherein each blade 140 is removably positioned thereon. Mounting head 110 could have two substantially solid support regions 112a and 112b and two substantially triangular shaped cutaway regions 114a and 114b defined therein. Each support region 112a and 112b could define substantially flat mounting wall 116a and 116b, respectively, wherein each mounting wall 116a and 116b could have a set of splines 118a and 118b, respectively, defined thereon. Each set of splines 118a and 118b could extend substantially perpendicular from distal end 120 of mounting head 110, substantially parallel with each other, defining a series of ridges 122 and troughs 124.

Each blade 140 could have at least one setting aperture 142 defined therethrough, proximate to mounting end 144 thereof, whereby at least one fastener 146 could be removably and securely positioned therethrough to lock each blade 140 on mounting head 110. The setting aperture 142 could be substantially oval shaped, wherein setting aperture 142 could be elongated and positioned substantially perpendicular to splines 70 of blade 140, thereby enabling utilization of fastener 146 for each of a plurality of user-selected blade positions, as a function of the provided adjustment splines 70 and 36.

In use, a user selects an unused blade 60 having a desired shaped cutting edge 68 and fully inserts blade 60 into arbor 22. Washer 40 and setscrew 38 are positioned and tightened to lock blade 60 into place. Proximate end 24 of arbor 22 is secured into a collet of a router, wherein motorized rotation thereof enables a user to cut a predefined shape, groove or pattern into a selected workpiece. Wherein blade 60 becomes worn, a user removes set screw 38 and washer 40, repositions blade 60 relative to splines 70 and 38, and replaces set screw 38 and washer 40, thereby compensating for blade wear and maintaining a consistent depth of cut. Wherein blade 60 becomes damaged, a user removes setscrew 38 and washer 40, removes the damaged blade, replaces the damaged blade with a new blade, secures washer 40 and set screw 38, and thereby eliminates the need to replace the entire bit.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A bit, comprising:
an elongated shank member having a first end and a second end, said first end dimensioned to be received by a rotational cutting tool;
at least one cutting member having a mounting region and at least one cutting end,
at least one means for removably securing at least one said cutting member proximate to said second end of said elongated shank member.

2. The bit of claim 1, wherein the circumference of said second end of said elongated shank member is greater than the circumference of said first end of said elongated shank member.

3. The bit of claim 1, wherein said means for removably securing at least one said cutting member proximate to said second end of said elongated shank member is at least one mounting aperture defined in said second end of said elongated shank member and at least one retention means for retaining said cutting member within said mounting aperture.

4. The bit of claim 3, wherein said retention means for retaining said cutting member within said mounting aperture comprises a threaded fastener.

5. The bit of claim 4, wherein said retention means for retaining said cutting member within said mounting aperture further comprises a substantially flat plate having at least one aperture defined therethrough, wherein said threaded fastener is removably positioned through said aperture of said plate.

6. The bit of claim 5, wherein said plate is a washer.

7. The bit of claim 1, further comprising a means for adjustably and reproducibly positioning said cutting member proximate to said second end of said elongated shank member.

8. The bit of claim 7, wherein said means for adjustably and reproducibly positioning said cutting member proximate to said second end of said elongated shank member is at least one mounting aperture defined in second end of said elongated shank member, said mounting aperture having at least one wall with a plurality of channels defined thereon, and wherein at least one surface of said cutting member has a plurality of channels defined thereon, said plurality of channels of said cutting member dimensioned to associate with said plurality of channels of said mounting aperture in a plurality of positions.

9. The bit of claim 8, wherein said channels are splines and wherein each said position of said plurality of positions is an incrementally precise positional change.

10. The bit of claim 1, wherein said cutting end of said cutting member is carbide.

11. The bit of claim 1, further comprising a bearing, said bearing rotationally positioned on said elongated shank proximate to said second end thereof.

12. The bit of claim 11, wherein said bearing is removable.

13. The bit of claim 1, wherein said cutting member further comprises at least one mounting aperture therethrough, and wherein said means for removably securing at least one said cutting member proximate to said second end of said elongated shank member comprises at least one mounting wall defined in said elongated shank member and at least one fastener removably positioned through at least one said mounting aperture on at least one said cutting member, said fastener removably retaining said cutting member on said mounting wall of said elongated shank member.

14. A rotational cutting tool bit assembly, comprising:
an elongated arbor member having a first end and a second end, said first end dimensioned to be received by a rotational cutting tool and said second end having a greater diameter than said first end;
at least one blade member having a mounting end and a cutting end, said mounting end having a plurality of elongated serrations defined thereon;
at least one blade retention aperture defined in said second end of said elongated arbor member, said blade retention aperture having a first inner wall and a second inner wall, said first inner wall of said blade retention aperture having a plurality of elongated serrations thereon; and
at least one guard means for retaining at least one said blade member within said blade retention aperture;
wherein said elongated serrations on said mounting end of said blade member are dimensioned to be removably received and mated with said elongated serrations of said first inner wall of said blade retention aperture in a plurality of positions.

15. The rotational cutting tool bit assembly of claim 14, wherein said guard means for retaining said blade member within said blade retention aperture comprises a threaded fastener.

16. The rotational cutting tool bit assembly of claim 15, wherein said guard means for retaining said blade member within said blade retention aperture further comprises a washer, said washer positioned on said threaded fastener.

17. The rotational cutting tool bit assembly of claim 14, wherein said serrations are precisely and incrementally positioned.

18. The rotational cutting tool bit assembly of claim 14, further comprising a pilot bearing.

19. The method of utilizing interchangeable, multi-positional blades from a multi-component bit for a rotational cutting tool, comprising the steps of:
a. obtaining a multi-component bit, said bit having a shank portion and at least one cutting blade removably carried by said shank portion, wherein said shank portion can be removably mounted to a rotational cutting tool;
b. operating the rotational cutting tool with said multi-component bit mounted thereto, wherein said cutting blade cuts a workpiece; and
c. repositioning said cutting blade relative to said shank portion, thereby compensating for wear thereto.

20. The method of utilizing interchangeable, multi-positional blades from a multi-component bit for a rotational cutting tool of claim 19, further comprising the step of:
d. removing said cutting blade and replacing said cutting blade, thereby compensating for damage and wear thereto.
